(19) United States
(12) Patent Application Publication
(10) Pub. No.: US 2011/0225036 A1
(43) Pub. Date: Sep. 15, 2011

(54) SYSTEM AND METHOD FOR DETERMING EARNINGS PER-CLICK FOR ADS PUBLISHED WITHIN A SOCIAL ADVERTISING PLATFORM

(76) Inventors: Bindu Priya REDDY, San Francisco, CA (US); Arvind Sundararajan, San Francisco, CA (US)

(21) Appl. No.: 13/044,488

(22) Filed: Mar. 9, 2011

Related U.S. Application Data
(60) Provisional application No. 61/339,808, filed on Mar. 10, 2010.

(51) Int. Cl. G06Q 30/00

(52) U.S. Cl. 705/14.42; 705/14.45

(57) ABSTRACT

One embodiment of the present invention sets forth a technique for determining an earnings per-click for a social publisher who, along with other types of digital content, publishes advertisements within a digital content distribution channel. The earnings per-click for a social publisher is determined based on an engagement score of the publisher that indicates the effectiveness of the publisher in terms of generating successful advertising outcomes. The engagement score is computed based on the performance of the advertisements published by the social publisher as well as different metrics associated with the social publisher that are collected from the advertising platform.

### CROSS-REFERENCE TO RELATED APPLICATIONS

This application claims benefit of United States provisional patent application filed on Mar. 10, 2010 and having a Ser. No. 61/339,808.

### BACKGROUND OF THE INVENTION

1. Field of the Invention

Embodiments of the present invention relate generally to internet advertising and, more specifically, to a system and method for determining earnings per-click for advertisements published within a social advertising platform.

2. Description of the Related Art

Social network advertising is a term that is used to describe a form of internet advertising that focuses on social networking sites. Typically, advertisers publish ads within a social networking platform that are displayed in conjunction with other content. These advertisements may be targeted based on information collected regarding the user base of the social networking platform. These advertisements, however, are largely ineffective in capturing the attention of users of the social networking platform.

In another form of social network advertising, users of the social networking platform select the advertisements that appear within their profiles for distribution to their audience. While such a technique allows for more flexibility provided to the users in terms of determining the particular advertisements that are distributed, there is typically no incentive for the users to make effective or relevant advertisement decisions. Therefore, the advertisements are, again, largely ineffective in capturing the attention of the audience of the user.

As the foregoing illustrates, what is needed in the art is an approach for incentivizing publishers of advertisements to increase their overall advertising effectiveness.

### SUMMARY OF THE INVENTION

One embodiment of the present invention sets forth a method for compensating publishers of advertisements within an electronic media advertising platform. The method includes the steps of determining an engagement score for a publisher of one or more advertisements within the electronic media advertising platform, the engagement score reflecting an amount paid to the publisher for each successful advertising outcome attributable to any of the one or more advertisements, receiving performance information related to a first advertisement published by the publisher within the electronic media advertising platform, wherein the performance information includes a number of successful advertising outcomes attributable to the first advertisement, comparing the performance information related to the first advertisement with an expected level of performance previously computed for the publisher, determining, based on the comparison, that the engagement score should be modified, and computing a new engagement score for the publisher based on the performance information related to the first advertisement.

One advantage of the disclosed technique is that the compensation given to a publisher for publishing advertisements is dependent directly on the effectiveness of the publisher in generating successful advertising outcomes. Such a framework incents publishers to select advertisements that are relevant to their audience and provides a mechanism for rewarding publishers that are successful advertisers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a social advertising environment configured to implement one or more aspects of the present invention;

FIG. 2 is a more detailed view of the earnings per-click computation engine of FIG. 1, according to one embodiment of the invention;

FIG. 3 is a flow diagram of method steps for computing an engagement score for a social publisher, according to one embodiment of the invention;

FIG. 4 is a flow diagram of method steps for performing a baseline analysis of the performance of an ad published by a social publisher, according to one embodiment of the invention;

FIG. 5 is a flow diagram of method steps for performing a metrics weight analysis based on the performance of a social publisher, according to one embodiment of the invention; and

FIG. 6 illustrates a system configured to implement one or more aspects of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

The term “social publisher” used herein refers to an individual or a group of individuals that has an internet presence and publishes content via at least one digital content distribution channel. The term “audience of a social publisher” used herein refers to the individuals that the social publisher is able to reach via the digital content distribution channels. The term “sponsor” used herein refers to an entity that produces a product or a service that is advertized via different digital content distribution channels.

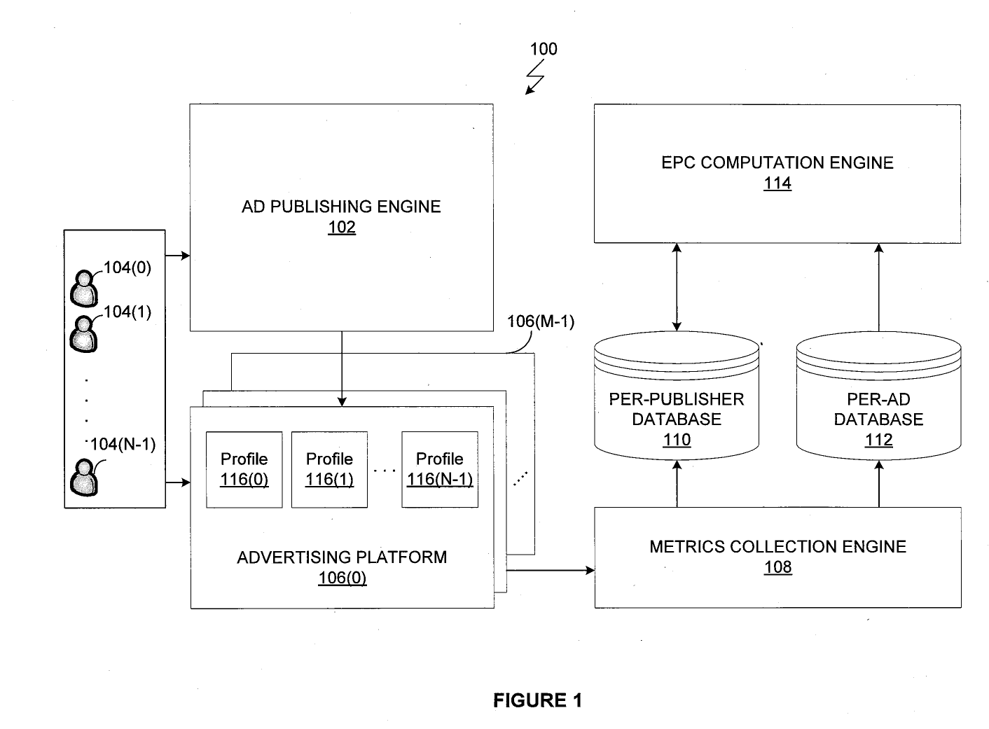

FIG. 1 illustrates a social advertising environment 100 configured to implement one or more aspects of the present invention. As shown, the social advertising environment 100 includes an advertisement (ad) publishing engine 102, social publishers 104, an advertising platform 106, a metrics collection engine 108, per-publisher data 110, per-ad data 112, an earning per-click (EPC) computation engine 114 and audience 118.

The ad publishing engine 102 distributes advertisements associated with different sponsors to the advertising platforms 106. In operation, the ad publishing engine 102 maintains a list of advertisements registered by sponsors, where each advertisement corresponds to a particular product and/or service offered by a sponsor. Social publishers 104 then select advertisements from the ad publishing engine 102 for distribution to the advertising platforms 106.

Each advertising platform 106 is a digital content distribution channel within which social publishers 104 publish digital content, such as articles, videos, photographs, etc. The digital content published by a particular social publisher 104 within an advertising platform 106 appears within the profile 116 associated with the social publisher 104 and can be viewed by the audience of the social publisher 104. For example, digital content published by social publisher 104(0) appears within the corresponding profile 116(0) of the advertising platform 106(0). The advertising platforms 106 are configured such that advertisements distributed by the ad publishing engine 102 can be published within the profiles 116.

In operation, to publish an advertisement within the profile 116 associated with a social publisher 104, the social publisher 104 first registers with the ad publishing engine 102. During the registration process, the social publisher 104 indicates to the ad publishing engine 102 the different advertising platforms 106 that include profiles associated with the social publisher 104 (referred to herein as “the indicated set of advertising platforms 106”). To publish an advertisement, the social publisher 104 selects, from the ad publishing engine 102, an advertisement for distribution as well as at least one advertising platforms 106 from the indicated set of advertising platforms 106. The selected advertisement is then distributed, by the ad publishing engine 102, to the profiles 116 of the social publisher 104 within the selected advertising platforms 106. Once published within the profiles 116, the audience of the social publisher 104 can view and interact with the advertisement within the profile 116.

The social publisher 104 is compensated each time the published advertisement produces a desired outcome specified by the sponsor of the advertisement, where such a desired outcome is referred to herein as a “conversion.” In one embodiment, a conversion is the sale of a product or service associated with the advertisement. In another embodiment, a conversion occurs when an audience member “clicks” on a universal resource locator (URL) embedded within the advertisement. In yet another embodiment, a conversion is a sign-up for a particular service associated with the advertisement.

The amount a social publisher 104 is compensated each time an advertisement published to his/her profile 116 results in a conversion (referred to herein as the “earning per-click”) is dependent upon an engagement score computed for the social publisher 104. The engagement score indicates the effectiveness of the social publisher 104 in generating conversions of advertisements published to his/her profile 116. At a high-level, the engagement score is based on factors such as the reach, i.e., the size of the audience, of the social publisher 104, selecting advertisements reflective of the tastes of the audience of the social publisher 104, etc. The following discussion describes the computation of the engagement score associated with a particular social publisher 104 in detail.

When a social publishers 104 first registers with the ad publishing engine 102, as described above, the metrics collection engine 108 collects metrics related to the social publisher 104 from the different advertising platforms 106 specified by the social publisher 104. The metrics collected by the metrics collection engine 108 vary based on the particular advertising platform 106 and may include demographic information, audience information, published content information, etc. Table 1 illustrates the metrics collected from three exemplary advertising platforms 106, Twitter, YouTube and Facebook. Persons skilled in the art would understand that the metrics in Table 1 are listed only for exemplary purposes and any other metrics from these advertising platforms 106 (or other sources) may also be collected by the metrics collection engine 108.

TABLE 1

| Platform | Metrics Collected for Social Publisher |
|---|---|
| Twitter | Number of Followers |
| | Number of Friends |
| | Number of Retweets |
| | Number of Mentions |
| | Friend/Follow Ratio |
| | Average Number of Clicks on Posted Digital Content |
| | Number of Posts in a Given Time Period |
| Facebook | Location |
| | Age |
| | Gender |
| | Number of Updates |
| | Average Number of Likes/Comments Per Update |
| | Average Number of Clicks on Posted Digital Content |
| | Number of Posts in a Given Time Period |
| YouTube | Number of Subscribers |
| | Average Number of Views Per Video |
| | Average Number of Likes/Comments Per Video |

The metrics collection engine 108 stores the collected metrics related to the social publisher 104 in the per-publisher database 110. Based on the metrics stored in the per-publisher database 110, the earnings per-click (EPC) engine 114 computes an initial engagement score of the social publisher 104. To compute the initial engagement score, the EPC engine 114 first, for a given advertising platform 106, assigns weights to each of the metrics collected from the advertising platform 106. The weighting scheme is pre-determined based on the types of metrics. The values of the metrics and the weights attached to the different metrics are then processed to compute the initial engagement score for the given advertising platform. Once the initial engagement score is computed for each of the advertising platforms 106 from which metrics were collected, a weighted average of the scores is taken to determine the initial engagement score of the social publisher 104. The earnings per-click of the social publisher 104 is then determined based on the initial engagement score via a correlation function. The engagement score and, therefore, the earnings per-click of the social publisher 104 continue to be updated as the values of metrics related to the social publisher 104 change.

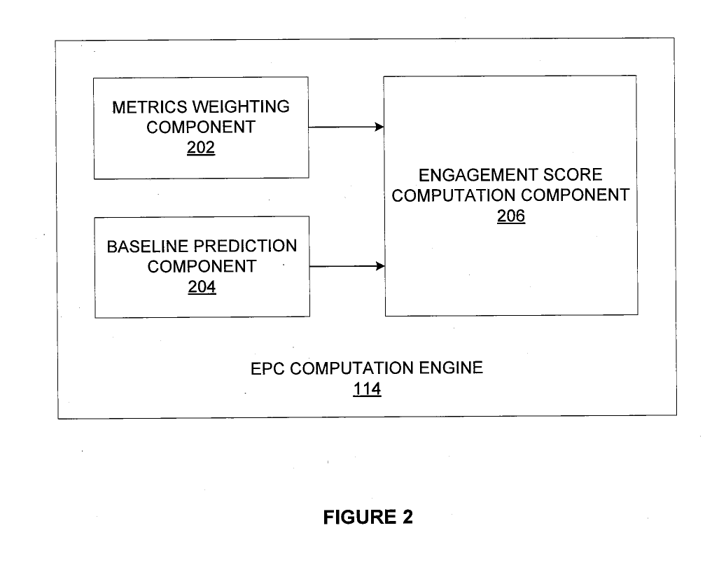

In addition to the initial information related to the social publisher 104, the metrics collection engine 108 also collects per-advertisement performance metrics as advertisements are published in the advertising platforms 106. The collected per-advertisement performance metrics are stored in the per-ad database 112. The per-advertisement performance metrics indicate, for each advertisement published within the advertising platforms 106, the number of resulting conversions for each social publisher 104 that published that particular advertisement. The EPC computation engine 114 processes the per-advertisement metrics to re-compute engagement scores associated with social publishers 104, as described in greater detail below in conjunction with FIG. 2.

FIG. 2 is a more detailed view of the EPC computation engine 114 of FIG. 1, according to one embodiment of the invention. As shown, the EPC computations engine 114 includes a metrics weighting component 202, a baseline prediction component 204 and an engagement score computation component 206.

As information related to the performance of advertisements published by a social publisher 104 within the advertising platforms 106 is gathered, the engagement score of the social publisher 104 is modified accordingly. At a high-level, the actual per-advertisement performance metrics related to advertisements published by the social publisher 104 are compared against pre-determined performance expectations. Based on the comparison, the EPC computation engine 114 determines the amount by which the engagement score should be changed. The EPC computation engine 114 computes two different types of pre-determined performance expectations, i.e., advertisement related performance and engagement score related performance.

For advertisement related performance expectations, the baseline prediction component 204, for a particular advertisement published by the social publisher 104, determines an expected number of conversions. The expected number of conversions is determined based on two factors. First, an average number of conversions that resulted when the advertisement was published across all social publishers 104 is computed. Second, an expected number of conversions for the particular social publisher 104 is computed based on metrics related to the social publisher 104 and collected from the advertising platforms 106. The average number of conversions for the advertisement and the expected number of conversions for the particular social publisher 104 are then combined to determine a baseline expectation of the number of conversions that should occur when the particular advertisement is published by the social publisher 104. This baseline expectation is the advertisement related performance expectation when a particular advertisement is published by the social publisher 104.

The engagement score computation component 206 then compares the advertisement related performance expectation with the actual performance of the advertisement published by the social publisher 104. The actual performance, as collected by the metrics collection engine 108, indicates the actual number of conversions that occurred when the advertisement was published. Based on the comparison, the engagement score computation component 206 re-computes the engagement score of the social publisher 104, if needed. When the actual performance is below the advertisement related performance expectation, then the engagement score computation engine 206 decreases the engagement score of the social publisher 104 by an amount proportional to the different between the actual and the expected performance. Conversely, when the actual performance is above the advertisement related performance expectation, then the engagement score computation engine 206 increases the engagement score of the social publisher 104 by an amount proportional to the different between the actual and the expected performance. The updated engagement score is used to compute a new earnings per-click for the social publisher 104 via the correlation function described above.

For engagement score related performance expectations, the metrics weighting component 202 determines an average expected number of conversions of advertisements published by the social publisher 104 based on the engagement score of the social publisher 104. To make such a determination, the metrics weighting component 202 computes the average number of conversions related to advertisements published by different social publishers 104 having engagement scores similar to the particular social publisher 104. The metrics weighting component 202 then compares the engagement score related performance expectation with the actual performance of the advertisement published by the social publisher 104.

Based on the comparison, the metrics weighting component 202 determines whether the weights associated with the different metrics associated with the social publisher 104 that were collected from the advertising platforms need to be updated. If needed, the weights of the different metrics are modified based on the difference between the engagement score related performance expectation and the actual performance of the advertisement published by the social publisher 104. The engagement score computation component 206 then re-computes the engagement score of the social publisher 104 based on the new weights.

In such a manner, the engagement score of a social publisher 104 is constantly modified according to the performance of advertisements published by the social publisher 104. In most cases, if the advertisements published by the social publisher 104 result in more conversions than expected, then the engagement score increases. However, if the advertisements published by the social publisher 104 result in less conversions than expected, then the engagement score decreases. Again, the amount paid out to a social publisher 104 for each conversion is dependent directly on the engagement score.

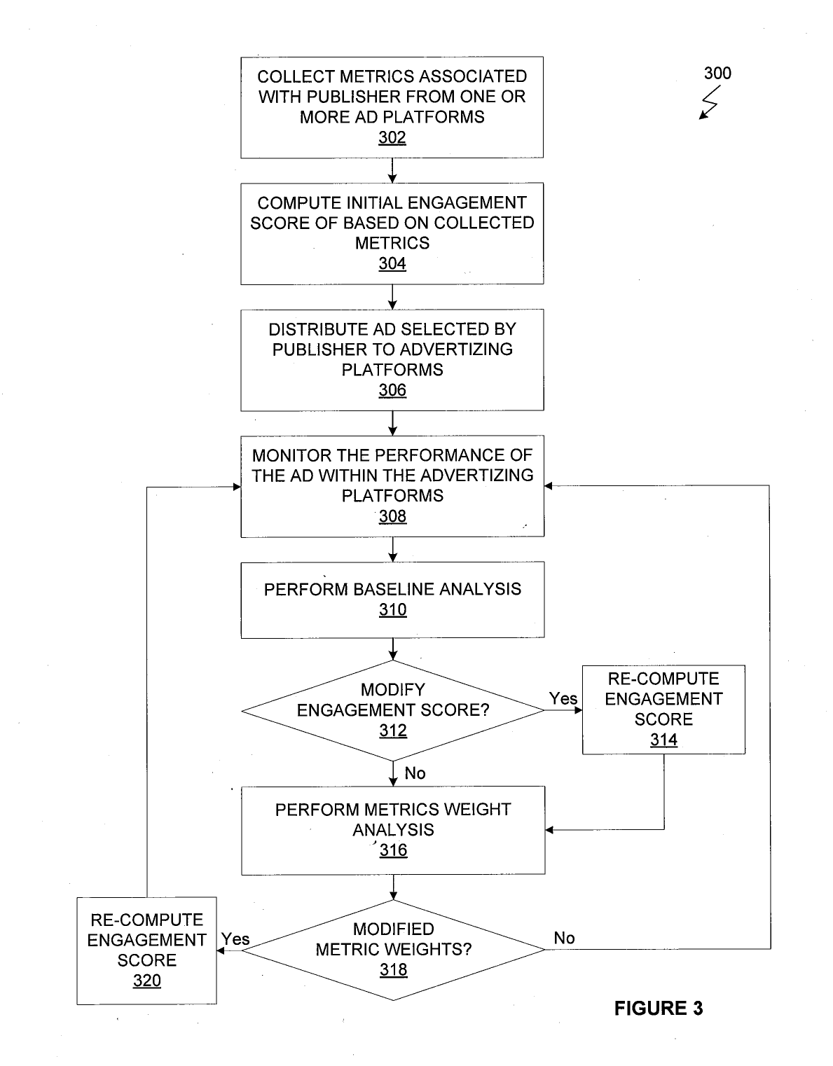

FIG. 3 is a flow diagram of method steps for computing an engagement score for a social publisher, according to one embodiment of the invention. Although the method steps are described in conjunction with the systems for FIGS. 1-2, persons skilled in the art will understand that any system configured to perform the method steps, in any order, is within the scope of the invention.

The method 300 begins at step 302, where a social publisher 104 registers with the ad publishing engine 102 and the metrics collection engine 108 collects metrics related to the social publisher 104 from the different advertising platforms 106 specified by the social publisher 104. As described above, the metrics collected by the metrics collection engine 108 vary based on the particular advertising platform 106 and may include demographic information, audience information, published content information, etc. The collected metrics are stored within the per-publisher database 110.

At step 304, the EPC computation engine 114 computes an initial engagement score of the social publisher 104 based on the collected metrics. In operation, the EPC computation engine 114 assigns different weights to the metrics related to the social publisher 104 stored in the per-publisher database 110. The engagements score is computed based on the weights associated with the metrics.

At step 306, the ad publishing engine 102 distributes an advertisement selected by the social publisher 104 to at least one advertising platform 106 selected by the social publisher 104. At step 308, the metrics collection engine 108 monitors the performance of the advertisement published by the social publisher 104 by collecting metrics related to the number of conversions that resulted from the advertisement. As previously described herein, a conversion is an action specified by a sponsor of an advertisement that indicates a positive outcome of the advertisement.

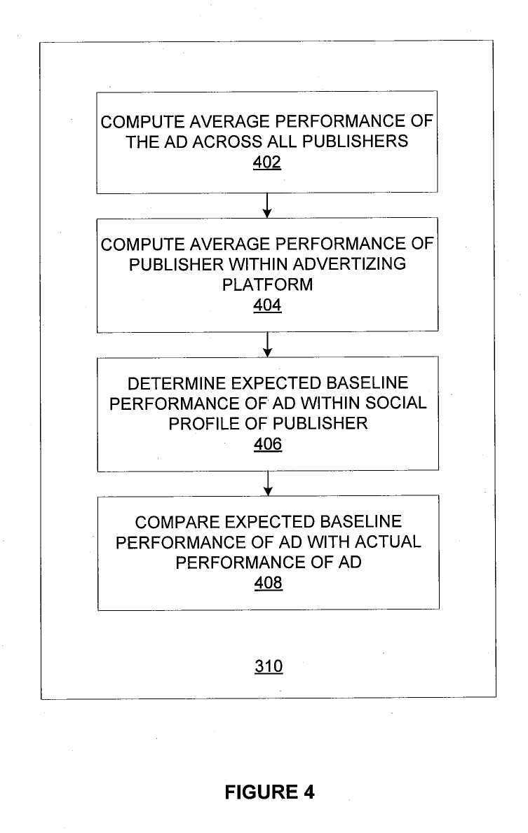

At step 310, the EPC computation engine 114 performs a baseline analysis based on the performance of the advertisement collected by the metrics collection engine 108. The details of the baseline analysis are described below in conjunction with FIG. 4. At step 312, the EPC computation engine 114 determines, based on the baseline analysis, whether the engagement score needs to be modified. If so, then the engagement score is re-computed by the EPC computation engine 114 based on the performance of the advertisement at step 314. If not, then the method 300 proceeds directly to step 316.

At step 316, the EPC computation engine 114 performs a metrics weight analysis based on the performance of the advertisement collected by the metrics collection engine 108. The details of the metrics weight analysis are described below in conjunction with FIG. 4. At step 318, the EPC computation engine 114 determines, based on the metrics weight analysis, whether the weights associated with the different metrics that contribute to the computation of the engagement score need to be modified. If so, then, at step 320, the EPC computation engine 114 modifies the weights according to the performance of the advertisement and re-computes the engagement score based on the updated weights at step 320. If not, then the method 300 returns back to step 308, where the performance of the advertisement within the advertising platform 106 continues to be monitored.

FIG. 4 is a flow diagram of method steps for performing a baseline analysis of the performance of an ad published by a social publisher, according to one embodiment of the invention. Although the method steps are described in conjunction with the systems for FIGS. 1-2, persons skilled in the art will understand that any system configured to perform the method steps, in any order, is within the scope of the invention.

At step 402, the baseline prediction component 204 computes an average number of conversions that resulted when the advertisement was published across all social publishers 104. At step 404, the baseline prediction component 204 computes an expected number of conversions for the particular social publisher 104 based on previously collected metrics related to the social publisher 104, such as the reach of the social publisher 104.

At step 406, the baseline prediction component 204 combines the average number of conversions for the advertisement and the expected number of conversions for the particular social publisher 104 to determine a baseline expectation of the number of conversions that should occur when the advertisement is published by the social publisher 104. This baseline expectation is the advertisement related performance expectation when a particular advertisement is published by the social publisher 104.

At step 408, the baseline prediction component 204 compares the advertisement related performance expectation with the actual performance information collected at step 308. Based on the comparison, the engagement score computation component 206 re-computes the engagement score of the social publisher 104, as previously described herein.

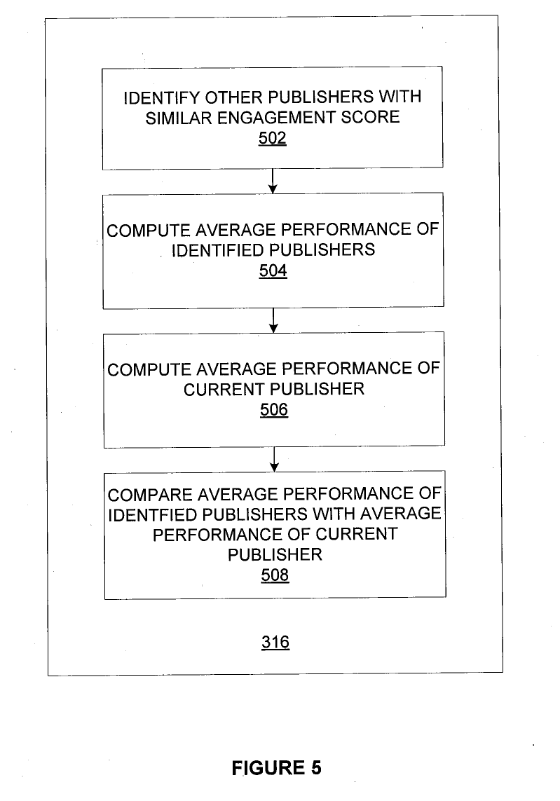

FIG. 5 is a flow diagram of method steps for performing a metrics weight analysis based on the performance of a social publisher, according to one embodiment of the invention. Although the method steps are described in conjunction with the systems for FIGS. 1-2, persons skilled in the art will understand that any system configured to perform the method steps, in any order, is within the scope of the invention.

At step 502, the metrics weighting component 202 identifies one or more social publishers 104 having a similar engagement score to the particular social publisher 104. At step 405, the metrics weighting component 202 computes the average number of conversions related to advertisements published by the identified social publishers 104 having engagement scores similar to the particular social publisher 104. At step 506, the metrics weighting component 202 then computes the average performance related to advertisements published by the particular social publisher 104 based on the metrics collected at step 308 described in conjunction with FIG. 3.

At step 508, the metrics weighting component 202 compares the average performance related to advertisements published by the particular social publisher 104 with the average number of conversions related to advertisements published by social publishers 104 having similar engagement scores. Based on the comparison, the weights of the different metrics are modified and the engagement score of the social publisher 104 is re-computed based on the new weights, as previously described herein.

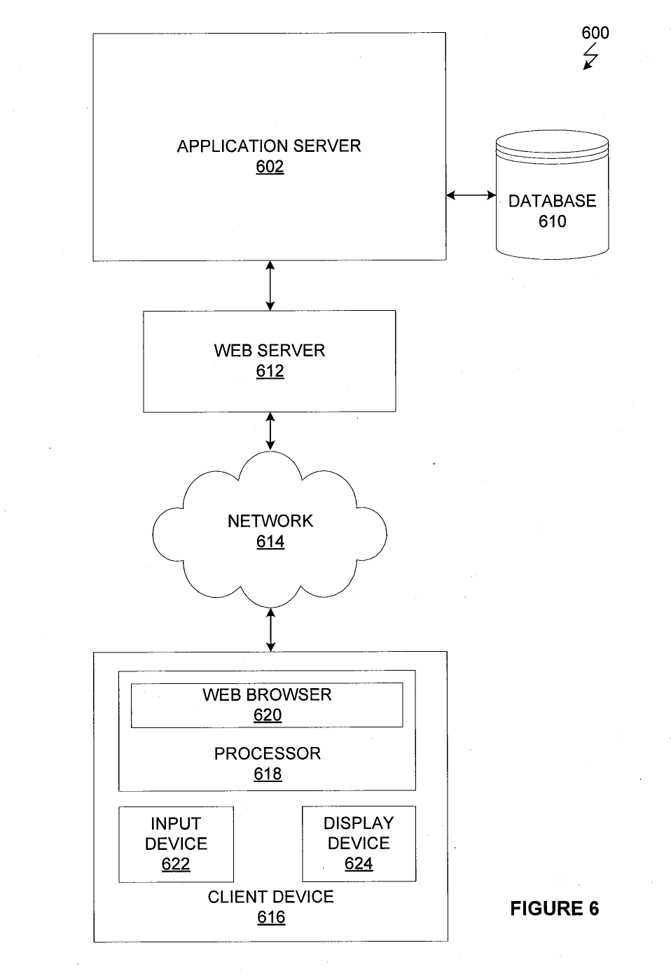

FIG. 6 illustrates a system 600 configured to implement one or more aspects of the present invention. As shown, the system 600 includes an application server 602, a database 610, a web server 612, a network 614 and a client device 616.

The application server 602 is configured to execute different applications, such as a software application 604, which includes instructions for implementing the methods described above in conjunction with FIGS. 1-5. In one embodiment, the application server 602 includes at least one of the ad publishing engine 102, the metrics collection engine 108 and the EPC computation engine 114. The application server 602 receives and transmits network requests to/from the web server 612. In an alternate embodiment, the system 600 may include multiple distributed application servers, such as application server 602, to process requests received by the web server 612 in a more efficient manner.

The application server 602 communicates with the database 610 transmit and retrieve information stored within the database 610. The database 610 is configured to store all information associated necessary to implement the methods of FIGS. 1-5, such as metrics information related to social publishers 104.

The web server 612 is configured to accept requests and data content from the client device 616, via the network 614, and transmit those requests and data content to the application server 602. The web server 612 is also configured to transmit data content received from the application server 602 to the client device 616.

In various embodiments the client device 616 may be a laptop computer, desktop computer, mobile device, personal digital assistant (PDA), set top box or any other type of computing device configured to perform the functions and operations contemplated herein. The client device 616 includes a processor 618, an input device 622 and a display unit 624. The processor 618 executes a web browser 620 that is configured to communicate with the web server 612, via the network 614. The data content received by the web browser 610 from the web server 612 may be displayed to a user of the client device 616, such as a social publisher 104, via the display 624. The data content received by the web browser may be manipulated by the user via the input device 622.

One advantage of the disclosed technique is that the compensation given to a publisher for publishing advertisements is dependent directly on the effectiveness of the publisher in generating successful advertising outcomes. Such a framework incents publishers to select advertisements that are relevant to their audience and provides a mechanism for rewarding publishers that are successful advertisers.

One embodiment of the invention may be implemented as a program product stored on computer-readable storage media within the endpoint device 108. In this embodiment, the endpoint device 108 comprising an embedded computer platform such as a set top box. An alternative embodiment of the invention may be implemented as a program product that is downloaded to a memory within a computer system, for example as executable instructions embedded within an internet web site. In this embodiment, the endpoint device 108 comprises the computer system.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

In view of the foregoing, the scope of the present invention is determined by the claims that follow.

We claim:

1. A computer-implemented method for compensating publishers of advertisements within an electronic media advertising platform, the method comprising:
determining an engagement score for a publisher of one or more advertisements within the electronic media advertising platform, the engagement score reflecting an amount paid to the publisher for each successful advertising outcome attributable to any of the one or more advertisements;
receiving performance information related to a first advertisement published by the publisher within the electronic media advertising platform, wherein the performance information includes a number of successful advertising outcomes attributable to the first advertisement;
comparing the performance information related to the first advertisement with an expected level of performance previously computed for the publisher;
determining, based on the comparison, that the engagement score should be modified; and
computing a new engagement score for the publisher based on the performance information related to the first advertisement.

2. The method of claim 1, wherein at least one other publisher publishes a second advertisement similar to the first advertisement within the electronic media advertising platform, and further comprising computing the expected level of performance for the publisher based on performance information related to the second advertisement.

3. The method of claim 2, wherein the expected level of performance computed for the publisher is further based on performance information related to a prior advertisement published by the publisher within the electronic media advertising platform.

4. The method of claim 3, wherein the step of computing the new engagement score comprises increasing or decreasing the engagement score determined for the publisher by an amount related to the difference between the performance information related to the first advertisement and the expected level of performance.

5. The method of claim 1, wherein the engagement score determined for the publisher is based on one or more weighted metrics collected via the electronic media advertising platform.

6. The method of claim 5, further comprising identifying at least one other publisher having an engagement score similar to the engagement score for the publisher, and computing the expected level of performance for the publisher based on performance information related to one or more advertisements published by the at least one other publisher.

7. The method of claim 6, wherein the step of computing the new engagement score for the publisher comprises modifying the weight associated with at least one of the weighted metrics according to the performance information related to the first advertisement and computing the new engagement score based on the modified weight.

8. The method of claim 1, wherein a successful advertising outcome comprises selling a product or a server associated with the first advertisement, having a third party sign up for a service associated with the first advertisement, or having a third party view published content associated with the first advertisement.

9. The method of claim 1, wherein the new engagement score reflects an amount paid to the publisher for each successful outcome attributable to a second advertisement published by the publisher within the electronic media advertising platform subsequent to publishing the first advertisement.

10. A computer-readable medium storing instructions that, when executed by a processor, cause the processor to compensate publishers of advertisements within an electronic media advertising platform, by performing the steps of:
determining an engagement score for a publisher of one or more advertisements within the electronic media advertising platform, the engagement score reflecting an amount paid to the publisher for each successful advertising outcome attributable to any of the one or more advertisements;
receiving performance information related to a first advertisement published by the publisher within the electronic media advertising platform, wherein the performance information includes a number of successful advertising outcomes attributable to the first advertisement;
comparing the performance information related to the first advertisement with an expected level of performance previously computed for the publisher;
determining, based on the comparison, that the engagement score should be modified; and
computing a new engagement score for the publisher based on the performance information related to the first advertisement.

11. The computer-readable medium of claim 10, wherein at least one other publisher publishes a second advertisement similar to the first advertisement within the electronic media advertising platform, and further comprising computing the expected level of performance for the publisher based on performance information related to the second advertisement.

12. The computer-readable medium of claim 11, wherein the expected level of performance computed for the publisher is further based on performance information related to a prior advertisement published by the publisher within the electronic media advertising platform.

13. The computer-readable medium of claim 12, wherein the step of computing the new engagement score comprises increasing or decreasing the engagement score determined for the publisher by an amount related to the difference between the performance information related to the first advertisement and the expected level of performance.

14. The computer-readable medium of claim 10, wherein the engagement score determined for the publisher is based on one or more weighted metrics collected via the electronic media advertising platform.

15. The computer-readable medium of claim 14, further comprising identifying at least one other publisher having an engagement score similar to the engagement score for the publisher, and computing the expected level of performance for the publisher based on performance information related to one or more advertisements published by the at least one other publisher.

16. The computer-readable medium of claim 15, wherein the step of computing the new engagement score for the publisher comprises modifying the weight associated with at least one of the weighted metrics according to the performance information related to the first advertisement and computing the new engagement score based on the modified weight.

17. The computer-readable medium of claim 10, wherein a successful advertising outcome comprises selling a product or a server associated with the first advertisement, having a third party sign up for a service associated with the first advertisement, or having a third party view published content associated with the first advertisement.

18. The computer-readable medium of claim 10, wherein the new engagement score reflects an amount paid to the publisher for each successful outcome attributable to a second advertisement published by the publisher within the electronic media advertising platform subsequent to publishing the first advertisement.

19. A computing device, comprising:
a memory; and
a processor configured to:
determine an engagement score for a publisher of one or more advertisements within the electronic media advertising platform, the engagement score reflecting an amount paid to the publisher for each successful advertising outcome attributable to any of the one or more advertisements,
receive performance information related to a first advertisement published by the publisher within the electronic media advertising platform, wherein the performance information includes a number of successful advertising outcomes attributable to the first advertisement,
compare the performance information related to the first advertisement with an expected level of performance previously computed for the publisher,
determine, based on the comparison, that the engagement score should be modified, and
compute a new engagement score for the publisher based on the performance information related to the first advertisement.

20. The computing device of claim 19, wherein the new engagement score reflects an amount paid to the publisher for each successful outcome attributable to a second advertisement published by the publisher within the electronic media advertising platform subsequent to publishing the first advertisement.
